(19) United States
(12) Patent Application Publication
(10) Pub. No.: US 2014/0095402 A1
(43) Pub. Date: Apr. 3, 2014

(54) System and Method of Scoring Candidate Audio Responses for a Hiring Decision

(71) Applicant: HireIQ Solutions, Inc., Alpharetta, GA (US)

(72) Inventors: Todd Merrill, Alpharetta, GA (US); Robert Forman, Alpharetta, GA (US); Mark Hopkins, Alpharetta, GA (US); Kevin Hegebarth, Johns Creek, GA (US); Ben Olive, Atlanta, GA (US)

(73) Assignee: HIREIQ SOLUTIONS, INC., Alpharetta, GA (US)

(21) Appl. No.: 14/039,664

(22) Filed: Sep. 27, 2013

Related U.S. Application Data
(60) Provisional application No. 61/707,337, filed on Sep. 28, 2012.

(51) Int. Cl. G06Q 10/10

(52) U.S. Cl. CPC G06Q 10/1053
USPC 705/321

(57) ABSTRACT

The Applicant has developed a system and method for extracting a large amount of raw emotional features from candidate audio responses and automatically isolating the relevant features. Relative rankings for each pool of candidates applying for a given position are calculated and candidates are grouped by predictive scores into broad categories.

### CROSS-REFERENCE TO RELATED APPLICATIONS

This application claims priority to U.S. Provisional Application No. 61/707,337, filed Sep. 28, 2012, the content of which is incorporated herein by reference in its entirety.

### FIELD

The present application relates to the field of candidate scoring. More specifically, the present application relates to the field of scoring candidate audio responses for a hiring decision.

### BACKGROUND

In matching specific audio features of applicants, such as pace of speech, there is a correlation with the resulting recruiter selection of a given candidate. A number of test features have been found to be correlative in specific scenarios where employers were testing for English fluency. In some cases native speaker features look significantly different from non-native speakers, and differentiation of candidates in the general case is needed.

### SUMMARY

The Applicant has developed a system and method for extracting a large amount of raw emotional features from candidate audio responses and automatically isolating the relevant features. Relative rankings for each pool of candidates applying for a given position are calculated and candidates are grouped by predictive scores into broad categories.

In one aspect of the present application, a computerized method of predicting acceptance of a plurality of candidates from an audio clip of an audio response collected from the plurality of candidates, comprises extracting a set of raw emotional features from the audio responses of each of the plurality of candidates, isolating a set of relevant features from the plurality of raw emotional features, calculating a relative ranking for a pool of the plurality of candidates for a position, and grouping the plurality of candidates into broad categories with the relative rankings.

In another aspect of the present application, a computer readable medium having computer executable instructions for performing a method of predicting acceptance of a plurality of candidates from a plurality of audio responses, comprises extracting a set of raw emotional features from an audio clip of the audio responses of each of the plurality of candidates, isolating a set of relevant features from the plurality of raw emotional features, calculating a relative ranking for a pool of the plurality of candidates for a position, and grouping the plurality of candidates into broad categories with the relative rankings.

In yet another aspect of the present application, system for predicting acceptance of a plurality of candidates from a plurality of audio responses, comprises a storage system, and a processor programmed to conduct a macro timing analysis on an audio response clip for each of the plurality of candidates, extract and isolate a set of relevant emotional features from the audio clip, and calculate a score for each of the plurality of candidates for a position with a set of attributes extracted from the macro timing analysis and the set of relevant emotional features, wherein the score corresponds to a relative ranking.

### BRIEF DESCRIPTION OF THE DRAWINGS

FIG. 1 is a flow diagram illustrating an embodiment of the system of the present application.

FIG. 2 is a flow chart illustrating an embodiment of the method of the present application.

FIG. 3 is a system diagram of an exemplary embodiment of a system for automated model adaptation.

### DETAILED DESCRIPTION OF THE DRAWINGS

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

The system and method of the present application may be effectuated and utilized with any of a. variety of computers or other communicative devices, exemplarily, but not limited to, desk top computers, laptop computers, tablet computers, or smart phones. The system will also include, and the method will be effectuated by a central processing unit that executes computer readable code such as to function in the manner as disclosed herein. Exemplarily, a graphical display that visually presents data as disclosed herein by the presentation of one or more graphical user interfaces (GUI) is present in the system. The system further exemplarily includes a user input device, such as, but not limited to a keyboard, mouse, or touch screen that facilitate the entry of data as disclosed herein by a user. Operation of any part of the system and method may be effectuated across a network or over a dedicated communication service, such as land line, wireless telecommunications, or LAN/WAN.

The system further includes a server that provides accessible web pages by permitting access to computer readable code stored on a non-transient computer readable medium associated with the server, and the system executes the computer readable code to present the GUIs of the web pages.

Embodiments of the system can further have communicative access to one or more of a variety of computer readable mediums for data storage. The access and use of data found in these computer readable media are used in carrying out embodiments of the method as disclosed herein.

Disclosed herein are various embodiments of methods and systems related to processing candidate audio responses to predict acceptance by hiring managers and to gauge key job performance indicators. Typically, a candidate may be presented with questions either by a live interviewer over a telephone line or through an automated interviewing process. in either case, the interview process is recorded, and the candidates audio responses may be separated from the interviewer questions for processing. It should also be noted that the system of the present application also includes the appropriate hardware for recording and providing a digital recording to the processor for processing, including but not limited to microphones, recording devices, telephone or Skype equipment, and any required additional storage medium. Gross signal measurements such as length of response, pace and silence are extracted and emotional content is extracted using varying models to optimize detection of specific emotional content of interest. All analytical elements are combined and compared against signal measurement data from a general population dataset to compute a relative score for a given candidate's verbal responses against the population.

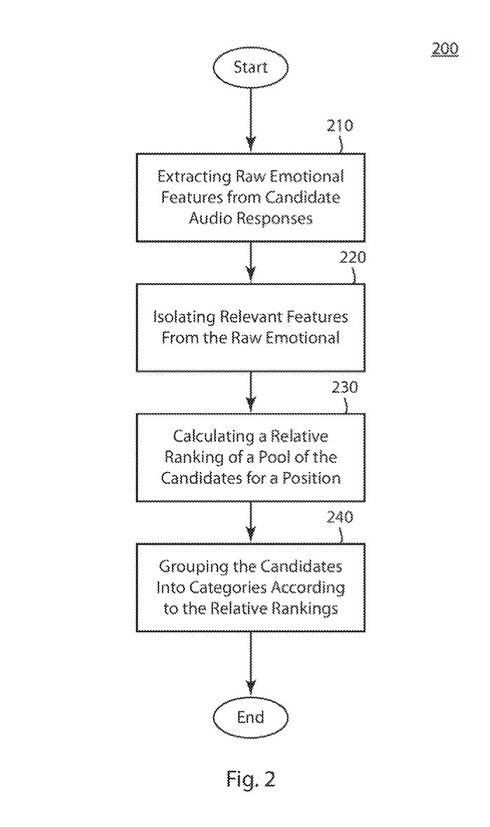

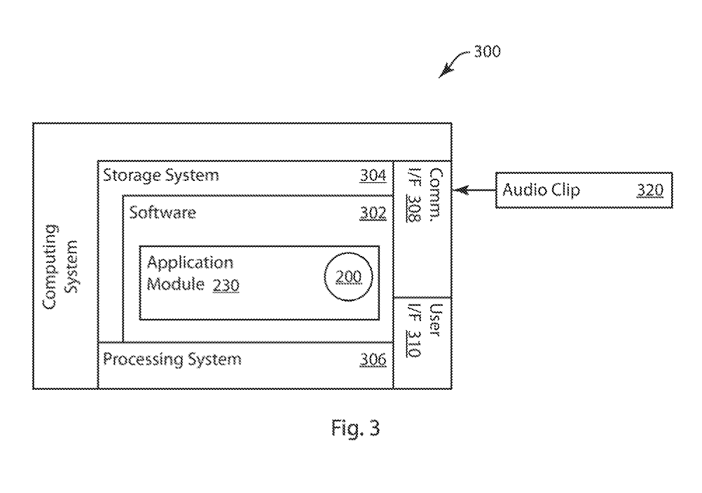

FIG. 2 is a flow diagram that depicts an exemplary embodiment of a method 200 of candidate scoring. FIG. 3 is a system diagram of an exemplary embodiment of a system 300 for candidate scoring. The system 300 is generally a computing system that includes a processing system 306, storage system 304, software 302, communication interface 308 and a user interface 310. The processing system 306 loads and executes software 302 from the storage system 304, including a software module 330. When executed by the computing system 300, software module 330 directs the processing system 306 to operate as described in herein in further detail in accordance with the method 200.

Although the computing system 300 as depicted in FIG. 2 includes one software module in the present example, it should be understood that one or more modules could provide the same operation. Similarly, while description as provided herein refers to a computing system 300 and a processing system 306, it is to be recognized that implementations of such systems can be performed using. one or more processors, which may be communicatively connected, and such implementations are considered to be within the scope of the description.

The processing system 306 can comprise a microprocessor and other circuitry that retrieves and executes software 302 from storage system 304. Processing system 306 can be implemented within a single processing device but can also be distributed across multiple processing devices or sub-systems that cooperate in existing program instructions. Examples of processing system 306 include general purpose central processing units, applications specific processors, and logic devices, as well as any other type of processing, device, combinations of processing devices, or variations thereof.

The storage system 304 can comprise any storage media readable by processing system 306, and capable of storing software 302. The storage system 304 can include volatile and non-volatile, removable and non-removable media implemented in any method or technology for storage of information, such as computer readable instructions, data structures, program modules, or other data. Storage system 204 can be implemented as a single storage device but may also be implemented across multiple storage devices or sub-systems. Storage system 304 can further include additional elements, such a controller capable, of communicating with the processing system 306.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In some implementations, the store media can be a non-transitory storage media. in some implementations, at least a portion of the storage media may be transitory. It should be understood that in no case is the storage media a propagated signal.

User interface 310 can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display an interface further associated with embodiments of the system and method as disclosed herein. Speakers, printers, haptic devices and other types of output devices may also be included in the user interface 310.

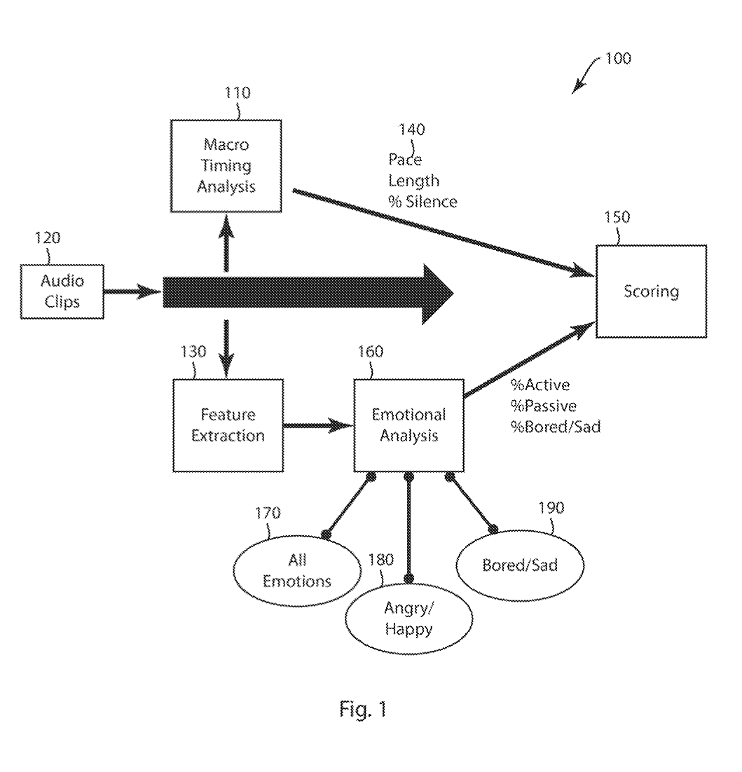

FIG. 1 illustrates the relationships of major components of the system. In further embodiments audio signals may be extracted from additional audio sources including, but not limited to video interview sessions. In a Macro Timing Analysis Module 110 of the system 100, gross analysis of the audio clips 120 occurs before in-depth analysis occurs. Basic attributes of the audio clip 120 is calculated including length of recording 140, percentage of silence 140 contained in the recording and pace of speech 140. Each gross attribute is recorded for the individual audio clip 120, and is incorporated into statistics for the general population of candidate responses to that question.

Still referring to FIG. 1, the system also includes extraction of detailed audio signal features with a feature extraction module 130. These audio features are used in a subsequent emotional analysis 160 in order to recognize emotional content of the audio clip 120. In one embodiment, the system 100 of the present application utilizes a feature extraction module 130 that includes a number of audio features. in one embodiment, the feature extraction module 130 utilizes a general audio signal processing, utilizing windowing functions such as Hamming, Hann, Gauss and Sine, as well as fast-fourier transform processing. The main feature extraction module 130 may also utilize a pre-emphasis filter, autocorrelation and cepstrum for general audio signal processing. The feature extraction module 130 is configured to extract speech related features such as signal energy, loudness, mel-spectra, MFCC, pitch and voice quality. The feature extraction module 130 also is configured to move average smoothing of feature contours, moving average mean subtraction, for example, for online ceptral mean subtraction and delta regression coefficients of arbitrary order. The feature extraction module 130 is also configured to extract means, extreme, moments, segments, peaks, linear and quadratic regression, percentiles, durations, onsets and DCT coefficients. While the foregoing features and functionality of the feature extraction module 130 is set forth above for an embodiment of the present application, it should be noted that other feature extraction modules and applications may be utilized.

Still referring to FIG. 1, an emotional analysis module 160 receives the output of the feature extraction module 130 in order to analyze the feature extraction module 130 output and detect and group emotions into various groups, for example an all-emotions category 170, angry/happy category 180, and bored/sad category 190. High-energy emotional content is critical to the system 100. Training models may be used to train several learning algorithms to detect such emotional content. In one embodiment, the Berlin Database of Emotional Speech (Emo-DB) is utilized for emotional analysis 160. It should be understood that additional embodiments may include other known proprietary emotional analysis 160 databases.

Emo-DB has advantages such that the emotions are short and well classified, as well as deconstructed for easier verification. The isolated emotions are also recorded m a professional studio, are high quality, and unbiased. However, the audio in Emo-DB is from trained actors and not live sample data. A person acting angry may have different audio characteristics than someone actually angry.

In another embodiment, building a learning model based on existing candidate data may be made. Also, another approach is to compare raw emotions against large feature datasets.

Another approach for increasing machine learning, accuracy is to pre-combine different datasets. For instance, when trying to identify speaker emotion, male and female speakers are first separated and then predicted sex-specific emotion classifications are applied. These pre-combined models perform with higher accuracy than the generic models.

In another embodiment, an additional blended approach may be utilized and professional actors may be grouped in to active (angry, happy) 180 speech groups, and then non-active (all the rest) 170, 190. They may also be grouped by passive (sad, bored) 190 speech groups, then median (all the rest) 170, 180. Emotional Analysis Models 160 may be built based on these blended groups and run through machine learning training and testing.

In embodiment illustrated in FIG. 1, three models are used to extract specific emotional characteristics: Angry/Happy model 180 to detect High Energy, Bored/Sad model 190 to detect Passive emotions and an All Emotions model 170 encompassing a broad spectrum of emotions to determine percentages of Bored/Sad 190 over the whole sample.

Emotional characteristics are incorporated, into population statistics as feedback as they are calculated in order to support and build large dataset analytics.

Still referring to FIG. 1, a score 150 is computed using, the Gross Audio metrics 140 as well as the emotional feature extraction 170, 180, 190 in combination. Three characteristics are distilled: Energy, Length, and Pace with exceptions for extreme negativism. Each characteristic is ranked against the peer population. If a candidate's responses substantially rank above a threshold, that candidate is scored a 2 for that attribute. If a candidate's responses are marginally ranked relative to peers, the candidate scores a 1 for that attribute and if the candidate is scored poorly relative to peers, the attribute is scored 0.

A matrix is computed over all possible scores for energy (N), length (L) and pace (P) and a final score between 1 and 18 is given for each candidate given the NLP scores over all of the candidate's responses. The NLP scores are then outputted to a user for review and evaluation.

Thresholds for each major attribute are configurable and determined using machine learning. The threshold limits are computed using the mean—a multiple of standard deviation for each attribute where the multiple constant is optimized to produce a high correlation of score to recruiter acceptance or other performance metric.

Now referring to FIG. 2 of the present application, a method 200 of the present application is illustrated. In step 210, raw emotional features are extracted from candidate audio responses. As discussed above, an audio clip of a sound recording of a candidate is processed and a macro timing analysis is carried out on the audio clip to extract pace, length, and percentage of silence within the audio clip, and feature extraction is utilized to remove and extract audio features from the audio clip. In step 220, an emotional analysis is carried out on the extracted features, and relevant features from the raw emotional analysis are derived such as percent active emotions, percent passive emotions, and percent bored/sad emotions. In step 230, a relative ranking of the pool of candidates for a position is calculated using the extracted and isolated features, including the pace, length and percentage of silence macro timing analysis features, as well as the percent active, percent passive and percent bored/sad features. Once the relative ranking is scored in step 230, the candidates are grouped into categories according to the relative rankings in step 240.

While embodiments presented in the disclosure refer to assessments for screening applicants in the screening process additional embodiments are possible for other domains where assessments or evaluations are given for other purposes.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A computerized method of predicting acceptance of a plurality of candidates from an audio response collected from the plurality of candidates, comprising:
extracting a set of raw emotional features from the audio responses of each of the plurality of candidates;
isolating a set of relevant features from an audio clip of the plurality of raw emotional features;
calculating, a relative ranking for a pool of the plurality of candidates for a position; and
grouping the plurality of candidates into broad categories with the relative rankings.

2. The method of claim 1 further comprising conducting a macro timing analysis on the audio responses of each of the plurality of candidates.

3. The method of claim 2, wherein the macro timing analysis extracts a plurality of attributes from the audio clips, including a pace attribute, a length attribute and a percent silence attribute.

4. The method of claim 1, wherein extracting the set of raw emotional features includes extracting a set of detailed audio signals from the audio clips with a feature extraction module.

5. The method of claim 4, wherein extracting the set of raw emotional features includes analyzing the set of detailed audio signals and detecting a plurality of emotions with an emotional analysis module.

6. The method of claim 5, wherein the emotional analysis module separates the plurality of emotions into a plurality of groups.

7. The method of claim 5, wherein the emotional analysis module is a speech database.

8. The method of claim 5. Wherein the emotional analysis module is a learning model, wherein the learning model is built through extracting the set of raw emotional features from a plurality of audio clips.

9. The method of claim I, wherein the relative ranking is a score calculated with the output of the macro timing analysis module and the emotional analysis module.

10. A computer readable medium having computer executable instructions for performing a method of predicting acceptance of a plurality of candidates from a plurality of audio responses, comprising:
extracting a set of raw emotional features from the audio responses of each of the plurality of candidates;
isolating a set of relevant features from an audio clip of the plurality of raw emotional features;
calculating a relative ranking for a pool of the plurality of candidates for a position; and
grouping the plurality of candidates into broad categories with the relative rankings.

11. The computer readable medium of claim 10 further comprising conducting a macro timing analysis on the audio responses of each of the plurality of candidates.

12. The computer readable medium of claim 11, wherein the macro timing analysis extracts a plurality of attributes from the audio clips, including a pace attribute, a length attribute and a percent silence attribute.

13. The computer readable medium of claim 10, wherein extracting the set of raw emotional features includes extracting a set of detailed audio signals from the audio dips with a feature extraction module.

14. The computer readable medium of claim 13, wherein extracting the set of raw emotional features includes analyzing the set of detailed audio signals and detecting a plurality of emotions with an emotional analysis meddle.

15. The computer readable medium of claim 14, wherein the emotional analysis module separates the plurality of emotions into a plurality of groups.

16. The computer readable medium of claim 14, wherein the emotional analysis module is a speech database.

17. The computer readable medium of claim 14, wherein the emotional analysis module is a learning model, wherein the learning model is built through extracting the set of raw emotional features from a plurality of audio clips.

18. The computer readable medium of claim 10, wherein the relative ranking is a score calculated with the output of the macro timing analysis module and the emotional analysis module.

19. A system for predicting acceptance of a plurality of candidates from a plurality of audio responses, comprising:
a storage system; and
a processor programmed to:
conduct a macro timing analysis on an audio response clip for each of the plurality of candidates;
extract and isolate a set of relevant emotional features from the audio clip; and
calculate a score for each of the plurality of candidates for a position with a set of attributes extracted from the macro timing analysis and the set of relevant emotional features, wherein the score corresponds to a relative ranking.
